(19) United States
(12) Patent Application Publication
(10) Pub. No.: US 2026/0244936 A1
(43) Pub. Date: Aug. 20, 2026

(54) METHODS AND SYSTEMS FOR PREDICTING SEQUENTIAL ACTIONS USING DEEP GENERATIVE MODELS

(71) Applicant: Shopify Inc., Ottawa (CA)

(72) Inventors: Andrew ARNOLD, New York, NY (US); Mikhail PARAKHIN, Redmond, WA (US)

(21) Appl. No.: 19/056,937

(22) Filed: Feb. 19, 2025

(51) Int. Cl. G06N 3/09; G06F 11/34; G06N 3/084

(52) U.S. Cl. CPC G06N 3/09; G06F 11/3438; G06N 3/084

(57) ABSTRACT

Methods and systems for implementing an action prediction framework associated with a user are described. An action prediction model generates a plurality of synthetic action sequences and corresponding synthetic end states for the user, based on a sequence of historical actions and corresponding historical end states. A plurality of pathways are projected through the plurality of synthetic action sequences, for assisting the user in arriving at a desired end state. During a training phase, a machine learning model is trained to learn a plurality of implicit features related to user behavior, for generating the synthetic action sequences and pathways. During an inference phase, the action prediction framework identifies waypoints associated with recommended user or system actions for assisting the user in reaching the end state more efficiently. The disclosed methods and systems may enable robust and efficient sequential action prediction while minimizing resource consumption associated with computationally expensive foundation models.

### FIELD

The present disclosure relates to machine learning, and, more particularly, to generating training data for training machine learning models, and yet more particularly, to methods and systems for predicting sequential actions using deep generative models.

### BACKGROUND

A foundation model is a type of deep machine learning (ML) model that has been pre-trained on a large scale, generalist (e.g., broad) dataset and can be adapted to perform a wide range of specialized downstream tasks across many use cases.

A large language model (LLM), or another generative model, may be considered as a type of foundation model. For example, a LLM may be trained to learn billions of parameters in order to model how words relate to each other in a textual sequence. Inputs to an LLM may be referred to as prompts. A prompt is a natural language input that includes instructions to cause the LLM to generate a desired output, including natural language text or other generative output in various desired formats.

### SUMMARY

A method and system are provided for implementing an action prediction framework associated with a user. In examples, an action prediction model generates a plurality of synthetic action sequences and corresponding synthetic end states for the user, based on a sequence of historical actions and corresponding historical end states. A plurality of pathways are projected through the plurality of synthetic action sequences, for assisting the user in arriving at a desired end state, for example, to attain a user goal or outcome. During a training phase, a machine learning model may be trained to learn a plurality of implicit features related to user behavior, for generating the synthetic action sequences and pathways. During an inference phase, the action prediction framework may identify waypoints associated with recommended user or system actions along the plurality of pathways for assisting the user in reaching the end state more efficiently. The disclosed methods and systems may enable robust and efficient sequential action prediction while minimizing resource consumption associated with computationally expensive foundation models.

Conventional recommendation models represent a class of machine learning models that use data to help predict, filter, and ultimately identify information of interest from a large (and continually growing) collection of options. Conventional recommendation models commonly utilize a collaborative filtering approach for filtering suggestions information (e.g., based on a similarity of a user's preferences or behaviors to other users) or a content-based filtering approach (e.g., based on a similarity of items to items a user has preferred in the past). However, the performance of conventional recommendation models is hindered by their inability to scale as model complexity and training time increases.

Another existing approach that aims to present relevant information to users is Monte Carlo Tree Search (MCTS). Rather than predicting relevant information based on similarities between object or user attributes, MCTS aims to present information based on predicting a sequence of user actions. While MCTS can be effective in certain domains, particularly in game-playing scenarios, it has several limitations in the context of general user action prediction, for example, MCTS works best in environments with clearly defined rules and end states, which may not be the case in many real-world user interaction scenarios. Furthermore, MCTS suffers from a lack of generalization, often requiring specific search trees to be generated for each new scenario, thereby limiting its ability to generalize across different user contexts or adapt in case the goals of the user change during the course of the browsing session.

Foundation models (such as large language models (LLMs), or other generative models) are deep learning models that have been pre-trained on a large scale, generalist (or broad) dataset and can be adapted to perform a wide range of specialized downstream tasks. For example, patterns and distributions contained in training data may be inherently learned by a foundation model and used to generate new data using the foundation model, responsive to user inputs. Foundation models are often characterized by their extensive number of parameters, which enable them to learn inherent correlations in unlabeled data.

Foundation models are widely known to be used for natural language processing or computer vision applications, however generative AI concepts may also be applied to recommendation problems. Such models may be referred to as “generative recommenders”, among other possibilities. For example, by introducing “user actions” as a modality in generative modeling, recommendation problems may be represented as sequence transduction tasks. An example architecture for such types of generative recommenders includes the Hierarchical Sequential Transduction Units (HSTU), which is described in: Zhai, Jiaqi, et al., “Actions speak louder than words: Trillion-parameter sequential transducers for generative recommendations”, arXiv preprint arXiv:2402.17152 (2024), the entirety of which is hereby incorporated by reference, although using other architectures is also contemplated.

In this regard, generative recommenders may overcome the problems with conventional recommendation models and/or tree searching approaches by effectively training on orders of magnitudes more data that is broad and general in nature, allowing these models to be flexible across a range of domains and/or use cases. However, due to their size and complexity, foundation models require considerable computational resources to train, implement and maintain. For example, foundation models are generally too large and computationally demanding to be deployed on edge or mobile devices, and similarly may introduce delays for use cases requiring low-latency or real-time user interaction, for example, via user interfaces.

Examples of the disclosed action prediction engine provide the technical effect that knowledge associated with a generative recommendation foundation model can be distilled into a smaller, more computationally efficient ML model using a synthetically generated training dataset. In this regard, a compressed model can be optimally trained via supervised learning, using a pre-generated pool of synthetic user action sequences, thereby reducing additional computational expense and keeping training data generation costs low. Furthermore, given that foundation models (including generative recommenders) require significant computational resources to train, implement and maintain, using a computationally efficient ML model for performing inference tasks (rather than deploying computationally expensive generative recommenders) further helps to reduce the use of computing resources (e.g., processing power, memory, computing time, etc.) and mitigate environmental emissions associated with such energy-intensive computation. In this regard, the disclosed solution may benefit from the improved performance associated with sequential user action prediction, with greater computational efficiency.

Examples of the proposed action prediction engine may improve the performance of user interfaces (UIs) by automatically adjusting graphical elements within the UI to allow the user to arrive at a desired synthetic end state more efficiently. For example, an output indicative of a recommended user action may be automatically provided to the user within a UI, for example, in a manner that makes it easier for the user to engage with or perform the recommended user action. Similarly, an intervention may be processed by the system such that a GUI element is automatically positioned within the GUI for assisting the user in navigating along a selected synthetic action sequence path toward the desired end state.

In some examples, the present disclosure describes a computer-implemented method. The method includes a number of steps, including: generating, by a first model, a plurality of synthetic action sequences and corresponding synthetic end states for a user, based on a set of historical action sequences and corresponding historical end states; projecting a plurality of synthetic action sequence paths through the plurality of synthetic action sequences, each synthetic action sequence path terminating at a respective synthetic end state of the plurality of synthetic end states; identifying a plurality of intermediate states in the plurality of synthetic action sequence paths that are each associated with a respective recommended user action, based on a relevance of the respective recommended action to a corresponding synthetic end state of the plurality of synthetic end states; and monitoring, in real-time, current actions performed by the user, for updating the plurality of synthetic action sequence paths or the plurality of intermediate states, based on an updated projection of the synthetic action sequence paths.

In an example of the preceding example aspect of the method, the method further comprising: providing, to a user device associated with the user, an output indicative of the recommended user action, to allow the user to arrive at a desired synthetic end state of the plurality of synthetic end states, by performing the recommended user action or responding to the output via a user input.

In an example of a preceding example aspect of the method, wherein the first model is a foundation model.

In an example of a preceding example aspect of the method, wherein the first model is a generative recommendation model.

In an example of a preceding example aspect of the method, wherein the first model includes a hypothetical sequential transduction unit (HSTU) architecture.

In an example of a preceding example aspect of the method, the method further comprising: prior to generating a plurality of synthetic action sequences and corresponding synthetic end states for the user: generating, by a foundation model, a training dataset corresponding to the plurality of synthetic action sequences and corresponding synthetic end states for the user, the training dataset comprising a plurality of data samples, each data sample representing a respective synthetic action in a respective synthetic action sequence; and training the first model, using the training dataset during a supervised learning process, to minimize a loss between a first model output and the plurality of synthetic action sequences and corresponding synthetic end states.

In an example of the preceding example aspect of the method, wherein the first model is a compressed model, and the foundation model includes HSTU.

In an example of a preceding example aspect of the method, wherein generating the training dataset comprises: receiving the set of historical action sequences and corresponding historical end states as tokenized data representing a time series of action sequences; predicting, by the foundation model, a next token representing a first predicted next action in the action sequence, based on the set of historical action sequences and corresponding historical end states; concatenating the first predicted next action with the set of historical action sequences to generate an updated set of historical action sequences; and predicting, by the foundation model, a next token representing a second predicted next action in the action sequence, based on the updated set of historical action sequences and corresponding historical end states.

In an example of a preceding example aspect of the method, wherein the first model is a neural network model, and training the first model comprises: performing a plurality of training iterations for training the first model during the supervised learning process that each comprise: generating, using the first model, the first model output, based on the training dataset; determining a loss based on the first model output and the plurality of synthetic action sequences and corresponding synthetic end states in the training dataset; computing a gradient with an objective of minimizing the loss; and backpropagating the loss through the first model to update values of weights of the first model, based on the computed gradient; and when the training iterations are complete, storing a final set of weights based on the updated weights.

In an example of a preceding example aspect of the method, wherein monitoring current actions comprises: comparing the current actions with one or more synthetic actions associated with a selected one of the plurality of synthetic action sequence paths to determine a deviation from the selected synthetic action sequence path; determining an updated desired end state of the plurality of synthetic end states for the user, the updated desired end state being associated with the current actions; projecting an updated synthetic action sequence path through an updated plurality of synthetic action sequences, the updated synthetic action sequence path terminating at the updated desired end state; and identifying an updated intermediate state along the updated synthetic action sequence path representing an updated recommended user action, based on a relevance of the updated recommended user action to the desired end state.

In some examples, the present disclosure describes a computer system including: a processing unit configured to execute computer-readable instructions to cause the system to: generate, by a first model, a plurality of synthetic action sequences and corresponding synthetic end states for a user, based on a set of historical action sequences and corresponding historical end states; project a plurality of synthetic action sequence paths through the plurality of synthetic action sequences, each synthetic action sequence path terminating at a respective synthetic end state of the plurality of synthetic end states; identify a plurality of intermediate states in the plurality of synthetic action sequence paths that are each associated with a respective recommended user action, based on a relevance of the respective recommended action to a corresponding synthetic end state of the plurality of synthetic end states; and monitor, in real-time, current actions performed by the user, for updating the plurality of synthetic action sequence paths or the plurality of intermediate states, based on an updated projection of the synthetic action sequence paths.

In an example of the preceding example aspect of the system, wherein the processing unit is further configured to execute computer-readable instructions to cause the computer system to: provide, to a user device associated with the user, an output indicative of the recommended user action, to allow the user to arrive at a desired synthetic end state of the plurality of synthetic end states, by performing the recommended user action or responding to the output via a user input.

In an example of a preceding example aspect of the system, wherein the first model is a foundation model.

In an example of a preceding example aspect of the system, wherein the first model is a generative recommendation model.

In an example of a preceding example aspect of the system, wherein the first model includes a hypothetical sequential transduction unit (HSTU) architecture.

In an example of a preceding example aspect of the system, wherein the processing unit is further configured to execute computer-readable instructions to cause the computer system to: prior to generating a plurality of synthetic action sequences and corresponding synthetic end states for the user: generate, by a foundation model, a training dataset corresponding to the plurality of synthetic action sequences and corresponding synthetic end states for the user, the training dataset comprising a plurality of data samples, each data sample representing a respective synthetic action in a respective synthetic action sequence; and train the first model, using the training dataset during a supervised learning process, to minimize a loss between a first model output and the plurality of synthetic action sequences and corresponding synthetic end states.

In an example of the preceding example aspect of the system, wherein the first model is a compressed model and the foundation model includes HSTU.

In an example of a preceding example aspect of the system, wherein in generating the training dataset, the processing unit is further configured to execute computer-readable instructions to cause the computer system to: receive the set of historical action sequences and corresponding historical end states as tokenized data representing a time series of action sequences; predict, by the foundation model, a next token representing a first predicted next action in the action sequence, based on the set of historical action sequences and corresponding historical end states; concatenate the first predicted next action with the set of historical action sequences to generate an updated set of historical action sequences; and predict, by the foundation model, a next token representing a second predicted next action in the action sequence, based on the updated set of historical action sequences and corresponding historical end states.

In an example of a preceding example aspect of the system, wherein the first model is a neural network model, and wherein in training the first model, the processing unit is further configured to execute computer-readable instructions to cause the computer system to: perform a plurality of training iterations for training the first model during the supervised learning process that each comprise: generating, using the first model, the first model output, based on the training dataset; determining a loss based on the first model output and the plurality of synthetic action sequences and corresponding synthetic end states in the training dataset; computing a gradient with an objective of minimizing the loss; and backpropagating the loss through the first model to update values of weights of the first model, based on the computed gradient; and when the training iterations are complete, store a final set of weights based on the updated weights.

In an example of a preceding example aspect of the system, wherein in monitoring current actions, the processing unit is further configured to execute computer-readable instructions to cause the computer system to: compare the current actions with one or more synthetic actions associated with a selected one of the plurality of synthetic action sequence paths to determine a deviation from the selected synthetic action sequence path; determine an updated desired end state of the plurality of synthetic end states for the user, the updated desired end state being associated with the current actions; project an updated synthetic action sequence path through an updated plurality of synthetic action sequences, the updated synthetic action sequence path terminating at the updated desired end state; and identify an updated intermediate state along the updated synthetic action sequence path representing an updated recommended user action, based on a relevance of the updated recommended user action to the desired end state.

In some examples, the present disclosure describes a non-transitory computer-readable medium storing instructions that, when executed by a processing unit of a computing system, cause the computing system to: generate, by a first model, a plurality of synthetic action sequences and corresponding synthetic end states for a user, based on a set of historical action sequences and corresponding historical end states; project a plurality of synthetic action sequence paths through the plurality of synthetic action sequences, each synthetic action sequence path terminating at a respective synthetic end state of the plurality of synthetic end states; identify a plurality of intermediate states in the plurality of synthetic action sequence paths that are each associated with a respective recommended user action, based on a relevance of the respective recommended action to a corresponding synthetic end state of the plurality of synthetic end states; and monitor, in real-time, current actions performed by the user, for updating the plurality of synthetic action sequence paths or the plurality of intermediate states, based on an updated projection of the synthetic action sequence paths.

In some examples, the computer-readable medium may store instructions that, when executed by the processor of the computing system, cause the computing system to perform any of the methods described above.

### BRIEF DESCRIPTION OF THE DRAWINGS

Reference will now be made, by way of example, to the accompanying drawings which show example embodiments of the present application, and in which:

FIG. 1A is a block diagram of a simplified convolutional neural network, which may be used in examples of the present disclosure;

FIG. 1B is a block diagram of a simplified transformer neural network, which may be used in examples of the present disclosure;

FIG. 2 is a block diagram of an example computing system, which may be used to implement examples of the present disclosure;

FIG. 3 is a simplified block diagram of an example architecture for an action prediction engine, in accordance with examples of the present disclosure;

FIG. 4 is a simplified schematic diagram of an example set of synthetic action sequence paths, in accordance with examples of the present disclosure;

FIG. 5 is a simplified block diagram of an example architecture for a more computationally efficient action prediction engine; and

FIG. 6 is an example of a simplified graphical user interface (GUI), which may be implemented by an example of the action prediction engine as disclosed herein;

FIG. 7 is a flowchart of an example method for generating a training dataset for training the compressed model, in accordance with examples of the present disclosure; and

FIG. 8 is a flowchart of an example method for implementing an action prediction framework associated with a user, in accordance with examples of the present disclosure.

Similar reference numerals may have been used in different figures to denote similar components.

### DETAILED DESCRIPTION

In various examples, the present disclosure describes methods and systems for implementing an action prediction framework associated with a user. Examples of the disclosed dynamic weighting module may improve the performance of sequential action prediction models using a computationally efficient ML model, thereby reducing the use of computing resources (e.g., processing power, memory, computing time, etc.) associated with energy-intensive foundation model computation.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

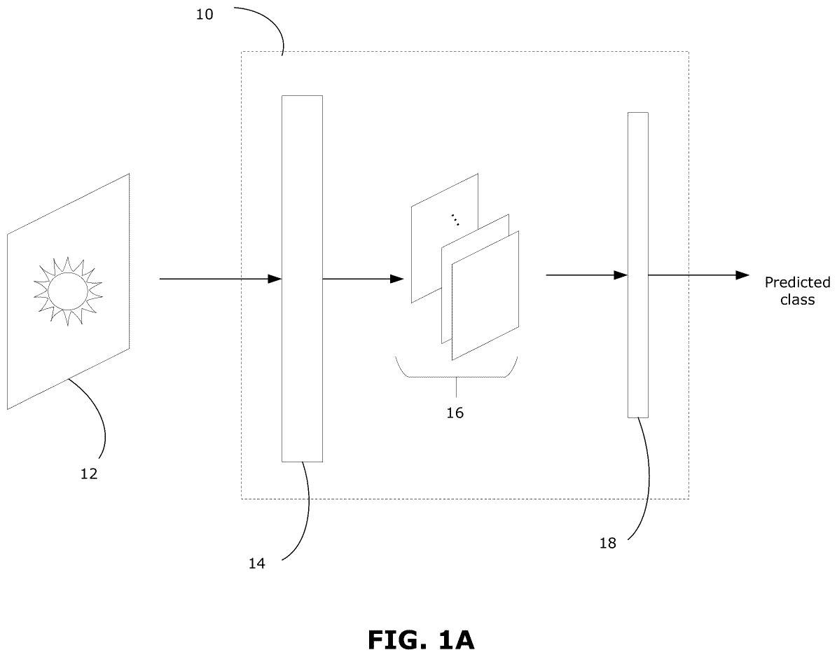

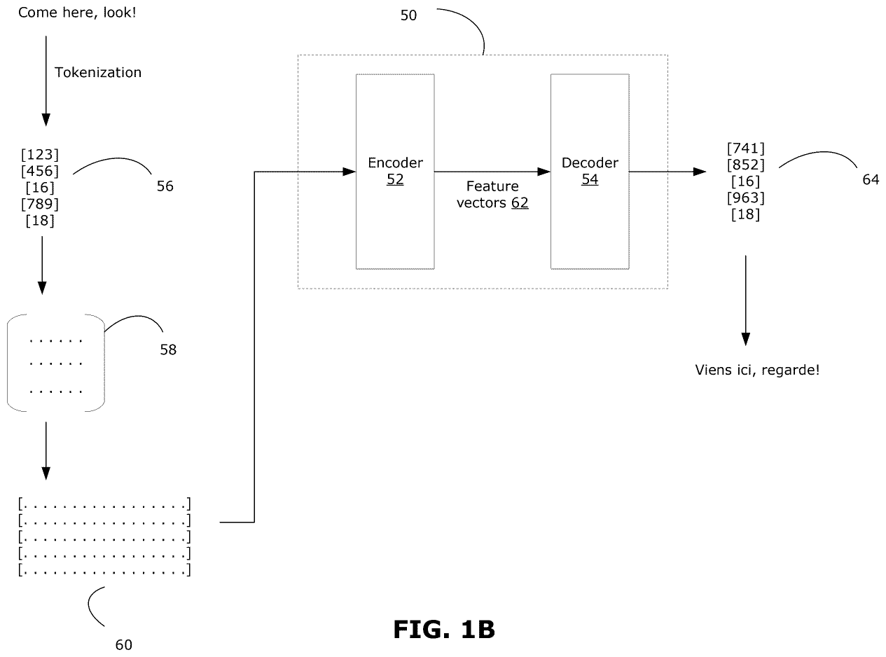

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labeled (e.g., annotated to indicate verbs, nouns, etc.) or unlabeled. LLMs may be trained on a large unlabeled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some preprocessing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space (or embedding space) may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

Although described above in the context of language tokens, embeddings and feature vectors are also commonly used to encode information about objects and their relationships with each other. For example, embeddings and feature vectors are frequently used in computer vision applications for object detection and semantic understanding. Embeddings that represent objects may be found in an embedding space, where the similarity and relationship of two objects (e.g., similarity between a cat and a lion) may be represented by the distance between the two corresponding embeddings in the embedding space.

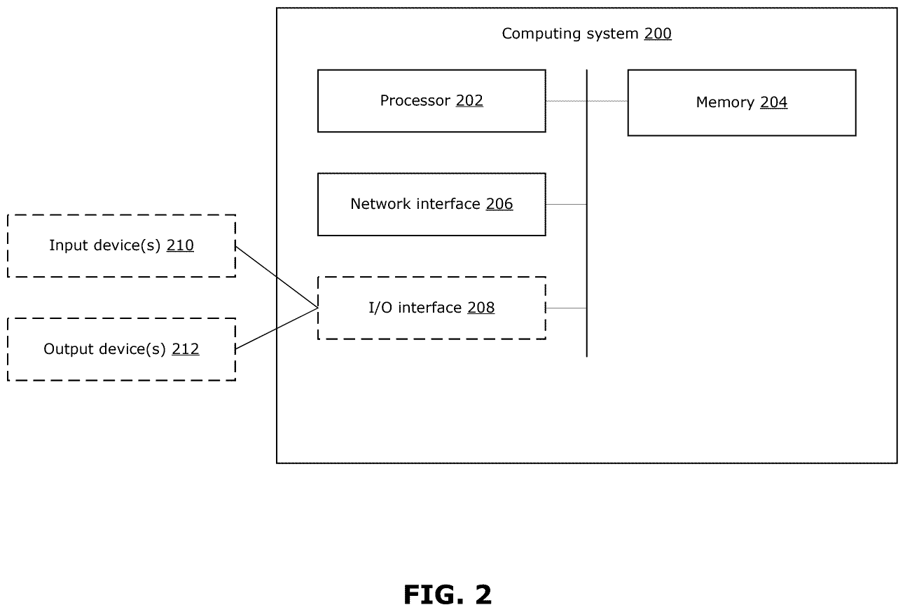

FIG. 2 illustrates an example computing system 200, which may be used to implement examples of the present disclosure. For example, the computing system 200 may be used to generate a plurality of synthetic action sequences and corresponding synthetic end states for a user, based on a set of historical action sequences and corresponding historical end states. Additionally or alternatively, the computing system 200 may be used to generate a training dataset for training a compressed model to generate the plurality of synthetic action sequences and corresponding synthetic end states for the user, as disclosed herein.

The example computing system 200 includes at least one processing unit and at least one physical memory 204. The processing unit may be a hardware processor 202 (simply referred to as processor 202). The processor 202 may be, for example, a central processing unit (CPU), a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 204 may include a volatile or non-volatile memory (e.g., a flash memory, a random access memory (RAM), and/or a read-only memory (ROM)). The memory 204 may store instructions for execution by the processor 202, to the computing system 200 to carry out examples of the methods, functionalities, systems and modules disclosed herein.

The computing system 200 may also include at least one network interface 206 for wired and/or wireless communications with an external system and/or network (e.g., an intranet, the Internet, a P2P network, a WAN and/or a LAN). A network interface may enable the computing system 200 to carry out communications (e.g., wireless communications) with systems external to the computing system 200, such as a foundation model residing on a remote system.

The computing system 200 may optionally include at least one input/output (I/O) interface 208, which may interface with optional input device(s) 210 and/or optional output device(s) 212. Input device(s) 210 may include, for example, buttons, a microphone, a touchscreen, a keyboard, etc. Output device(s) 212 may include, for example, a display, a speaker, etc. In this example, optional input device(s) 210 and optional output device(s) 212 are shown external to the computing system 200. In other examples, one or more of the input device(s) 210 and/or output device(s) 212 may be an internal component of the computing system 200.

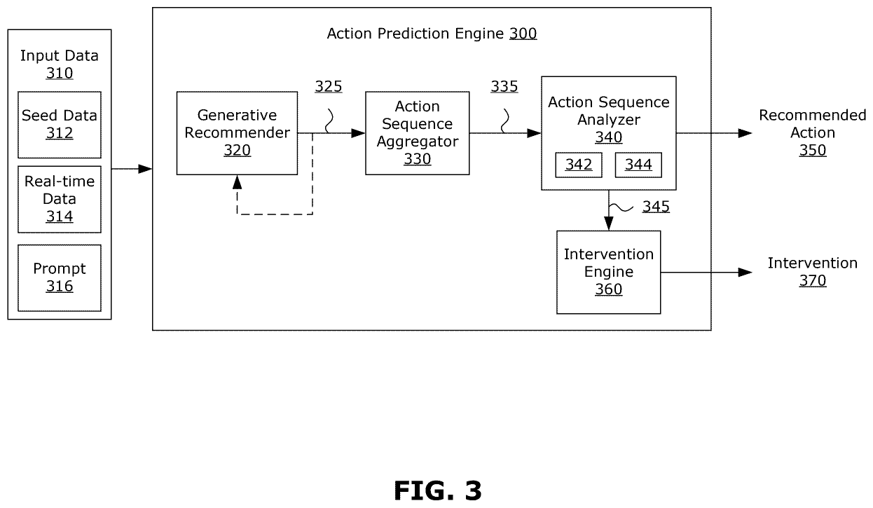

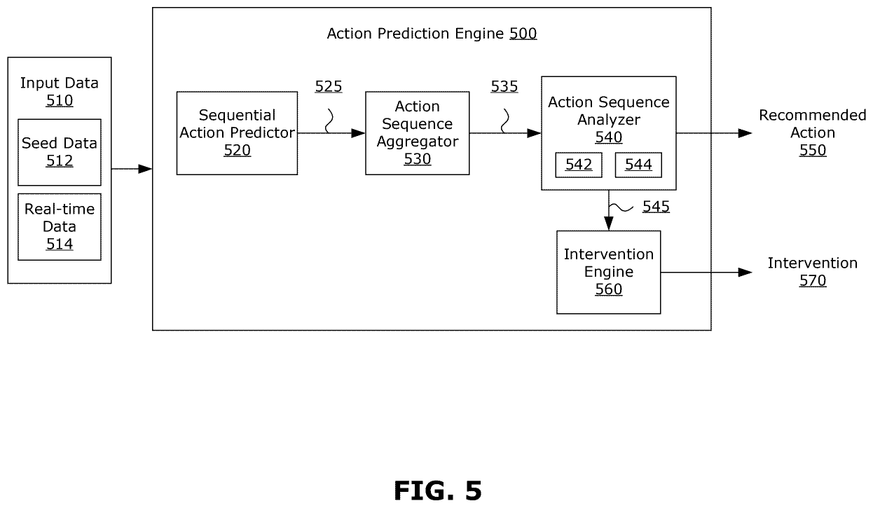

In the example of FIG. 2, the computing system 200 may store in the memory 204 computer-executable instructions, which may be executed by a processing unit such as the processor 202, to implement one or more embodiments disclosed herein. For example, the memory 204 may store instructions for implementing an action prediction engine 300, described with respect to FIG. 3 below or for implementing an action prediction engine 500, described with respect to FIG. 5 below. In some examples, the computing system 200 may be a server of an online platform that provides the action prediction engine 300 or 500 as a web-based or cloud-based service that may be accessible by a user device (e.g., via communications over a wireless network). Other such variations may be possible without departing from the subject matter of the present application.

As will be discussed further below, the present disclosure describes an example action prediction engine, for example, for predicting action sequences that are associated with recommended user actions and interventions.

FIG. 3 shows a simplified block diagram of an example architecture for an action prediction engine 300, in accordance with examples of the present disclosure. The action prediction engine 300 may be a software that is implemented in the computing system 200 of FIG. 2, in which the processor 202 is configured to execute instructions of the action prediction engine 300 stored in the memory 204. The action prediction engine 300 includes a generative model, such as a generative recommender 320, an action sequence aggregator 330, an action sequence analyzer 340 and an intervention engine 360. It should be understood that the blocks 320, 330, 340 and 360 are exemplary and not intended to be limiting. For example, the action prediction engine 300 may include a greater or fewer number of modules than that shown. As well, operations described as being performed by a particular module may be additionally or alternatively performed by another subsystem. The action prediction engine 300 may receive input data 310 and may generate a recommendation 350 and/or an intervention 370, for example, to allow a user to arrive at a desired end state by performing the recommended user action 350 or responding to the intervention 370 via a user input.

In examples, the input data 310 may be received by the action prediction engine 300, for example, associated with a user, among other possibilities. In examples, the user may have a user ID or be associated with a user account or an electronic device, for example, where information corresponding to past action sequences associated with the user, the account or the electronic device (e.g., performed by the user, or performed by a software of the electronic device, among other possibilities) may be stored. In examples, a time series dataset including a set of historical action sequences and corresponding historical end states, for example, spanning a pre-determined duration (e.g., 1 month, 3 months, 6 months, etc.) may be provided to the action prediction engine 300 as seed data 312. In other embodiments, for example, real-time actions (e.g., occurring at the current time) and associated with the user, the account or the electronic device may be monitored and provided to the action prediction engine 300 as real-time data 314. In examples, real-time data 314 may provide the action prediction engine 300 with local context for the user, among other possibilities. In examples, the computing system 200 may be instrumented with software necessary to monitor and capture real-time actions associated with the user, the account or the electronic device, among other possibilities. In an exemplary embodiment, a user may be interacting with a content generation application, such as within a collaborative document sharing platform, for example, for editing a document, and the computing system 200 may be configured to capture user actions in real-time, such as edits to the document, authoring information, permissions granted to others to view and/or edit the document etc., or system actions (e.g., back-end actions performed by the computing system 200), among other possibilities. In examples, the computing system 200 may also capture other actions performed by the user and associated with other applications on the same electronic device (such as in a calendar application, a chat application, a collaborative software, a search engine, an email application, a website etc.) or associated with the same user account. In examples, each historical action and/or real-time action may include corresponding metadata, such as the user ID, timestamp, action source (e.g., application where the action was performed), among other possibilities.

In examples, the seed data 312 and the real-time data 314 may represent tokenized data, for example, the historical sequences of actions (e.g., seed data 314) and any current local context (e.g., real-time data 314) may be converted into tokens representing a time series of action sequences, for providing to a generative model for predicting a next token (e.g., a next action) in the sequence.

In examples, a prompt 316 may be provided to the action prediction engine 300, for example, for providing instructions to the generative recommender 320, such as to generate a recommendation for the user. In examples, the generative recommender 320 may represent a foundation model (such as a generative recommendation model, among other generative models), and may be configured to generate a recommendation based on a predicted next action 325 in a sequence of actions. In some embodiments, for example, the generative recommender may represent a sequential generative recommender, where “actions” may be introduced as a modality in generative modeling using a foundation model or another generative model, and recommendation problems may be represented as sequence transduction tasks. An example architecture for such types of generative models is the Hierarchical Sequential Transduction Units (HSTU) architecture, although using other architectures is also contemplated. An example sequential generative recommender that includes Hierarchical Sequential Transduction Units for outputting sequential recommendation tasks is described in: Zhai, Jiaqi, et al., “Actions speak louder than words: Trillion-parameter sequential transducers for generative recommendations”, arXiv preprint arXiv:2402.17152 (2024), the entirety of which is hereby incorporated by reference.

In examples, the generative recommender 320 may output one or more predicted next actions 325, based on the input data 310. For example, the generative recommender 320 may receive the seed data 312 and the real-time data 314 as a sequence of tokens, and may predict a next token in the sequence representing a first predicted next action 325 corresponding to time t₁, for example, conditioned on the local context of user history and conditioned on all training. In examples, the first predicted next action 325 corresponding to time t₁ may be fed back into the generative recommender 320, for example, for use in an autoregressive decoding process for generating a sequence of predicted next actions 325 (e.g., by recursively predicting the next output based on previous outputs). In examples, the generative recommender 320 may concatenate the first predicted next action 325 corresponding to time t₁ with the real-time data 314 (e.g., for representing a pseudo context to the generative recommender 320 for predicting further next actions in a sequence of next actions) and the generative recommender 320 may use the seed data 312 and the pseudo context (e.g., including the previous outputs) for generating a second predicted next action 325 corresponding to time t₂. In examples, the generative recommender 320 may repeat this process for a pre-determined number of iterations (e.g., 100 iterations, among other possibilities) and may provide the one or more predicted next actions 325 to the action sequence aggregator 330 for generating a respective synthetic action sequence 335. In examples, the generated synthetic action sequence 335 may represent time-series data, among other possibilities.

In examples, the action sequence analyzer 350 may receive the one or more synthetic action sequences 335 and may generate corresponding synthetic end states 342 for the user, based on the input data 310. In examples, the synthetic end state 342 may represent the user's intent. In examples, the action sequence analyzer 350 may project a plurality of synthetic action sequence paths 345 through the plurality of synthetic action sequences 335, for example, where each synthetic action sequence path 345 terminates at a respective end state 342 of the plurality of synthetic end states. In this regard, a synthetic action sequence path can represent a user journey, for example, where the synthetic end state 342 marks the end of the journey, and the action sequence represents all of the steps the user took to arrive at the end state 342. In examples, the synthetic end state may be associated with a positive user sentiment, for example, for a scenario where the user achieves their intended goal, or in other examples, the synthetic end state 342 can be associated with a negative user sentiment, for example, for a scenario where the user becomes frustrated and abandons their task, among other possibilities.

In examples, the action sequence analyzer 340 may also identify a plurality of intermediate states 344 along the plurality of synthetic action sequence paths 345, for example, where each intermediate state 344 may be associated with a respective recommended user action 350. In examples, a recommended action 350 may represent an action taken by the user that increases the likelihood of the user reaching a desired end state 342 or allows the user to reach the desired end state 342 more quickly.

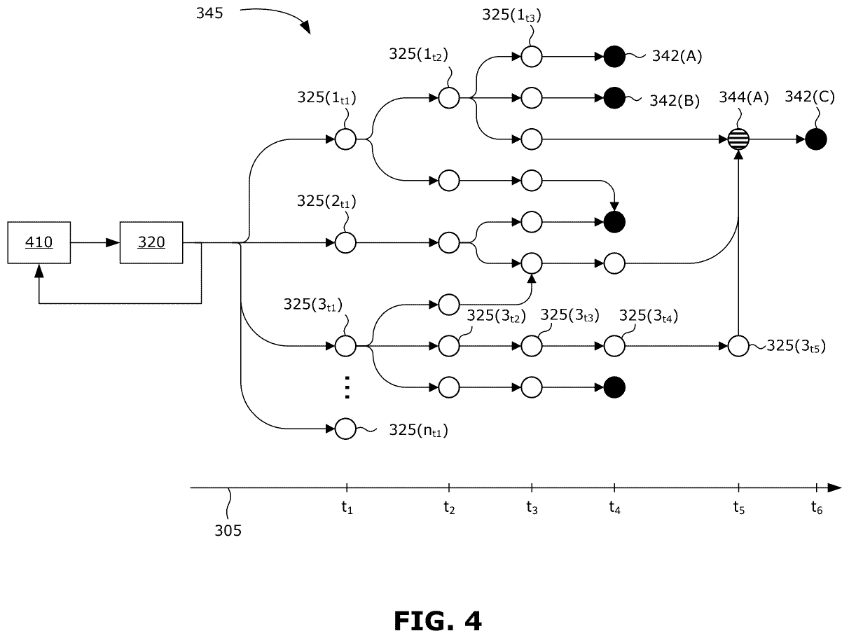

FIG. 4 shows a simplified schematic diagram of an example set of synthetic action sequence paths 345, in accordance with examples of the present disclosure. In examples, the set of synthetic action sequence paths 345 is configured as a connected network of nodes, where each node represents either a predicted next action 325, a synthetic end state 342 or an intermediate state 344 corresponding to a time stamp (e.g., t₁, t₂ etc.), among other possibilities, for example, provided along a timeline 305, and edges indicate the connections or relationships between nodes, for example, indicating an order and/or a proximity between nodes along a respective synthetic action sequence path 345. Although the set of synthetic action sequence paths 345 is shown in an example configuration of nodes and edges, it should be understood that this example is not intended to be limiting.

In examples, set of synthetic action sequence paths 345 includes a plurality of predicted next actions 325, each generated by the generative recommender 320 based on a sequence of input events 410 and each designated with a respective label indicating an ID of a corresponding synthetic action sequence 335 and a time stamp. For example, a predicted next action corresponding to time t₁ and associated with a first synthetic action sequence 335 may be labelled as 325(1ₜ₁), where the value “1” signifies the ID of the corresponding synthetic action sequence path 345. Similarly, a predicted next action corresponding to time t₂ and associated with a third synthetic action sequence path 345 may be labelled as 325(3ₜ₂), where the value “3” signifies the ID of the corresponding synthetic action sequence path 345. In examples, a plurality of synthetic end states 342 (e.g., 342(A), 342 (B), 342 (C) etc.) are also shown in the network of FIG. 4 as solid nodes with labels for distinguishing synthetic end states 342 from one another, and with each synthetic action sequence path 345 terminating at a respective synthetic end state of the plurality of synthetic end states 345. In examples, FIG. 4 also provides an intermediate state 344(A) shown as a striped node. Although only one intermediate state 344 is shown in the example network of FIG. 4, it is understood that this example should not be limiting.

In some embodiments, for example, the output of the generative recommender 320 may not be deterministic, rather there may be a distribution of predicted outputs that can be sampled. For example, in generating the plurality of synthetic action sequences 335, the action prediction engine 300 may sample the distribution to select a first predicted next action 325 corresponding to time t₁ and then the action prediction engine 300 may sample the distribution to select another first predicted next action corresponding to time t₁ associated with another synthetic action sequence 335, and may continue until a sampling criteria has been met (e.g., for a pre-determined number of samples, such as 1000 samples, among other possibilities).

In examples, as described with respect to FIG. 3, the generative recommender 320 may cooperate with the action sequence aggregator 330 to aggregate a plurality of sequentially predicted next actions 325 into a respective plurality of synthetic action sequences 335, where each synthetic action sequence 335 terminates at a respective end state 342. In examples, the action sequence analyzer 340 may receive the plurality of synthetic action sequences 335 and may classify the plurality of end states 342 according to a classification scheme, for example, based on an outcome of the end state 342 (e.g., positive, negative etc.) or based on a predicted sentiment of the user (achieved goal, abandoned task etc.), among other possibilities. In examples, the action sequence analyzer 340 may apply a clustering algorithm to the plurality of synthetic action sequences 335, to collapse the plurality of synthetic action sequences 335 into a connected network of nodes, for example, by identifying common nodes (e.g., representing the same or similar actions) or which may be associated with specific classes of the plurality of synthetic end states 342, among other possibilities, and which may consequently be grouped or collapsed into a single node. In this regard, correlations may be determined between the common nodes and corresponding synthetic end states 342, among other possibilities, where positive or negative correlations provide insight into relationships that may exist between the actions performed at the common nodes and an outcome (or end state) of a corresponding sequence of actions. In this regard, intermediate states 344 may be generated based on the correlations between the common nodes and the plurality of synthetic end states 342.

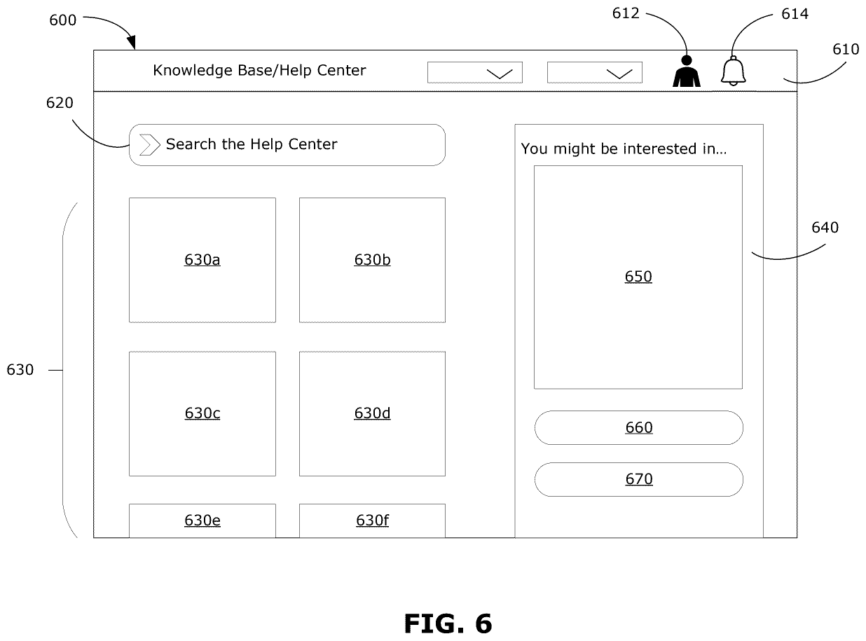

Returning to FIG. 3, in examples, a recommended action 350 may be mapped to a corresponding intermediate state 344 based on a relevance of the recommended action 350 to the desired synthetic end state 342. In examples, a recommended action 350 may be provided to a user via a user interface (as described with respect to FIG. 6 below).

In examples, the intervention engine 360 may receive the plurality of synthetic action sequence paths 345 and may generate an intervention 370 for providing to a user device associated with the user. In examples, the intervention 370 may represent an output that is indicative of the recommended user action 350, to allow the user to arrive at a desired synthetic end state 342 of the plurality of synthetic end states more easily, for example, by performing the recommended user action 350 or responding to the output via a user input. In examples, an intervention 370 may include user-facing actions or backend actions (e.g., facilitated by the system and which may be invisible to the user or that the user might not become aware of right away). In examples, a non-exhaustive list of example interventions may include customization of search results, selecting content for outputting to the user device, prioritizing content or resources for output within a UI, or otherwise customizing a UI/UX associated with the user device, adding a user to a distribution or an account (e.g., automatically subscribing to a group chat, a collaborative platform or a mailing list), changing an account status or extending a credit to a user, among other possibilities.

In examples, the action sequence analyzer 340 may monitor current actions performed by a user in real-time and may track each current user action along the plurality of synthetic action sequence paths 345. In examples, monitoring current user actions may allow for the plurality of synthetic action sequence paths 345 or the plurality of intermediate states 344 to be updated, for example, to reflect changes in a user's intent, among other possibilities, that may be reflected in the user's current actions. For example, the action sequence analyzer 340 may compare the current user actions with one or more synthetic actions 325 associated with a selected one of the plurality of synthetic action sequence paths 345 to determine a deviation from the selected synthetic action sequence path 345. In examples, a deviation may represent a scenario where the current user actions do not align with one or more synthetic actions 325 in the selected synthetic action sequence path 345. In examples, responsive to the monitoring of the current user actions, the desired end state 342 for the user may be updated to reflect the current user actions. For example, a user who was interacting with an educational platform, for example, with a desired end state representative of learning a particular concept in preparation for an exam, may decide to begin interacting with a map application to plan their route for traveling to the exam location. In this regard, the current user actions may reflect a change in a desired end state for the user corresponding to obtaining a route for travelling to the exam location with minimal traffic delays. In examples, the generative recommender 320, in cooperation with the action sequence aggregator 330 may generate an updated plurality of synthetic action sequences 335, for example, to reflect the monitored current events. For example, the current user events may be added to the real-time data 314 and input to the generative recommender 320 as input data 310 for generating the plurality of synthetic action sequences 335. In examples, responsive to generating the updated plurality of synthetic action sequences 335, the action sequence analyzer 340 may determine an updated desired end state 342 for the user and may project an updated plurality of synthetic action sequence paths 345 through the updated plurality of synthetic action sequences 335, where the updated synthetic action sequence path terminates at an updated desired end state 342. In examples, the action sequence analyzer 340 may also identify an updated intermediate state 344 along the updated synthetic action sequence path 345, where the updated intermediate state 344 represents an updated recommended user action 350 for assisting the user in reaching the updated desired synthetic end state 342. In examples, the updated intermediate state 344 may be identified based on a relevance of the updated recommended user action 350 to the updated desired end state 342.

Given that foundation models require considerable computational resources (e.g., memory, processing power, etc.) to train, implement and maintain, in some embodiments, for example, it may be computationally expensive for the action prediction engine 300 to use the generative recommender 320 for performing inference tasks, and particularly real-time inference tasks. For example, a user engaging with the action prediction engine 300 may cause the action prediction engine 300 to continually update and/or re-generate the plurality of synthetic action sequences 335 and/or the plurality of synthetic action sequence paths 345. In this regard, use of complex foundation models for such inference tasks may be computationally expensive, time consuming and costly. To address these challenges, the use of a smaller, more computationally efficient model may provide an improved approach for sequential user action prediction that is flexible, scalable and more computationally efficient.

FIG. 5 shows a simplified block diagram of an example architecture for a more computationally efficient action prediction engine 500, in accordance with examples of the present disclosure. The action prediction engine 500 may be a software that is implemented in the computing system 200 of FIG. 2, in which the processor 202 is configured to execute instructions of the action prediction engine 500 stored in the memory 204. The action prediction engine 500 includes a trained sequential action predictor 520, an action sequence aggregator 530, an action sequence analyzer 540 and an intervention engine 560. It should be understood that the blocks 520, 530, 540 and 560 are exemplary and not intended to be limiting. For example, the action prediction engine 500 may include a greater or fewer number of modules than that shown. As well, operations described as being performed by a particular module may be additionally or alternatively performed by another subsystem. The action prediction engine 500 may receive input data 510 and may generate a recommendation 550 and/or an intervention 570, for example, to allow a user to arrive at a desired end state by performing the recommended user action 550 or responding to the intervention 570 via a user input.

In examples, the input data 510 may be received by the action prediction engine 500, for example, associated with a user, among other possibilities. In examples, the user may have a user ID or be associated with a user account or an electronic device, for example, where information corresponding to past action sequences associated with the user, the account or the electronic device (e.g., performed by the user, or performed by a software of the electronic device, among other possibilities) may be stored. In examples, a time series dataset including a set of historical action sequences and corresponding historical end states, for example, spanning a pre-determined duration (e.g., 1 month, 3 months, 6 months, etc.) may be provided to the action prediction engine 500 as seed data 512. In other embodiments, for example, real-time actions (e.g., occurring at the current time) and associated with the user, the account or the electronic device may be monitored and provided to the action prediction engine 500 as real-time data 514. In examples, real-time data 514 may provide the action prediction engine 500 with local context for the user, among other possibilities. In examples, the computing system 200 may be instrumented with software necessary to monitor and capture real-time actions associated with the user, the account or the electronic device, among other possibilities.

In examples, the seed data 512 and the real-time data 514 may represent tokenized data, for example, the historical sequences of actions (e.g., seed data 514) and any current local context (e.g., real-time data 514) may be converted into tokens representing a time series of action sequences, for providing to a generative model for predicting a next token (e.g., a next action) in the sequence.

In examples, the sequential action predictor 520 may output one or more predicted next actions 525, based on the input data 510. For example, the sequential action predictor 520 may be a neural network that has been trained (e.g., using knowledge distillation using training data that was generated by the generative recommender 320 of FIG. 3), for example, to generate the one or more predicted next actions 525.

In examples, the action sequence aggregator 530 may receive the one or more predicted actions 525 and may aggregate predicted actions 525 into respective pluralities of synthetic action sequences 535, where each synthetic action sequence 535 terminates at a respective end state 542. In examples, the action sequence analyzer 540 may receive the plurality of synthetic action sequences 335 and may classify the plurality of end states 542 according to a classification scheme, for example, based on an outcome of the end state 542 (e.g., positive, negative etc.) or based on a predicted sentiment of the user (achieved goal, abandoned task etc.), among other possibilities. In examples, the action sequence analyzer 540 may apply a clustering algorithm to the plurality of synthetic action sequences 535, to collapse the plurality of synthetic action sequences 535 into a connected network of nodes, for example, by identifying common nodes (e.g., representing the same or similar actions) or which may be associated with specific classes of the plurality of synthetic end states 542, among other possibilities, and which may consequently be grouped or collapsed into a single node. In this regard, correlations may be determined between the common nodes and corresponding synthetic end states 542, among other possibilities, where positive or negative correlations provide insight into relationships that may exist between the actions performed at the common nodes and an outcome (or end state) of a corresponding sequence of actions. In this regard, intermediate states 544 may be generated based on the correlations between the common nodes and the plurality of synthetic end states 542.

In examples, each intermediate state 544 may be associated with a respective recommended user action 550. In examples, a recommended action 550 may be mapped to a corresponding intermediate state 544 based on a relevance of the recommended action 550 to the desired synthetic end state 542. In examples, a recommended action 550 may be provided to a user via a user interface (as described with respect to FIG. 6 below).

In examples, the intervention engine 560 may receive the plurality of synthetic action sequence paths 545 and may generate an intervention 570 for providing to a user device associated with the user. In examples, the intervention 570 may represent an output that is indicative of the recommended user action 550, to allow the user to arrive at a desired synthetic end state 542 of the plurality of synthetic end states more easily, for example, by performing the recommended user action 550 or responding to the output via a user input. In examples, an intervention 570 may include user-facing actions or backend actions (e.g., facilitated by the system and which may be invisible to the user or that the user might not become aware of right away). In examples, a non-exhaustive list of example interventions may include customization of search results, selecting content for outputting to the user device, prioritizing content or resources for output within a UI, or otherwise customizing a UI/UX associated with the user device, adding a user to a distribution or an account (e.g., automatically subscribing to a group chat, a collaborative platform or a mailing list), changing an account status or extending a credit to a user, among other possibilities.

In examples, the action sequence analyzer 540 may monitor current actions performed by a user in real-time and may track each current user action along the plurality of synthetic action sequence paths 545. In examples, monitoring current user actions may allow for the plurality of synthetic action sequence paths 545 or the plurality of intermediate states 544 to be updated, for example, to reflect changes in a user's intent, among other possibilities, that may be reflected in the user's current actions. For example, the action sequence analyzer 540 may compare the current user actions with one or more synthetic actions 525 associated with a selected one of the plurality of synthetic action sequence paths 545 to determine a deviation from the selected synthetic action sequence path 545. In examples, a deviation may represent a scenario where the current user actions do not align with one or more synthetic actions 525 in the selected synthetic action sequence path 545. In examples, responsive to the monitoring of the current user actions, the desired end state 542 for the user may be updated to reflect the current user actions. In examples, the sequential action predictor 520, in cooperation with the action sequence aggregator 530 may generate an updated plurality of synthetic action sequences 535, for example, to reflect the monitored current events. For example, the current user events may be added to the real-time data 514 and input to the sequential action predictor 520 as input data 510 for generating the plurality of synthetic action sequences 535. In examples, responsive to generating the updated plurality of synthetic action sequences 535, the action sequence analyzer 540 may determine an updated desired end state 542 for the user and may project an updated plurality of synthetic action sequence paths 545 through the updated plurality of synthetic action sequences 535, where the updated synthetic action sequence path terminates at an updated desired end state 542. In examples, the action sequence analyzer 540 may also identify an updated intermediate state 544 along the updated synthetic action sequence path 545, where the updated intermediate state 544 represents an updated recommended user action 550 for assisting the user in reaching the updated desired synthetic end state 542. In examples, the updated intermediate state 544 may be identified based on a relevance of the updated recommended user action 550 to the updated desired end state 542.

FIG. 6 illustrates an example of a simplified graphical user interface (GUI) 600, which may be implemented by an example of the action prediction engine 300 of FIG. 3 or the action prediction engine 500 of FIG. 5, as disclosed herein (e.g., using the example method 800). In the example of FIG. 6, the GUI 600 is a web-based educational platform or knowledge base, although other use cases may be applicable. It should be understood that this example is not intended to be limiting.

In this simple example, the GUI 600 may have multiple pages or tabs, as indicated in the navigation bar 610, along with elements for accessing a user account 612 or for receiving notifications 614, among other possibilities. The GUI 600 includes an input portion 620 in which the user may enter text input, such as a search query or another user input. In some examples, the user may provide input by other means, such as voice input and/or touch input.

The GUI 600 includes a plurality of GUI elements, for example, content objects 630 that may be automatically configured within the GUI 600, for example, with the most relevant GUI elements content objects 630 positioned near the top of the webpage (e.g., content objects 630a or 630b), moderately relevant content objects positioned near the middle of the webpage (e.g., content objects 630c or 630d) and less relevant content objects positioned near the bottom of the viewing window (e.g., content objects 630e or 630f, for example, where the user may be required to scroll the website to view the content objects), among other possibilities. The GUI 600 may also include other GUI elements configured to provide output to the user or receive input from the user, such as content objects, text boxes, buttons etc., such as shown by objects 640, 650, 660 and 670, among other possibilities. In this regard, the system may cooperate with the GUI 600 to automatically organize GUI elements within the GUI 600 according to a need of the user or the system, among other possibilities.

In examples, the action prediction engine 300/500 may be configured to output the recommended action 350/550 via the GUI 600 and/or to process the intervention 370/570 via a UI module (not shown) of the system, for example, to allow the user to arrive at a desired synthetic end state of the plurality of synthetic end states more efficiently. For example, an output indicative of the recommended user action 350/550 may be automatically provided to the user within the GUI 600, such that the user is more likely to engage with or perform the recommended user action 350/550. Similarly, an intervention 370/570 may be processed by the system such that a GUI element such as a button is automatically positioned within the GUI for assisting the user in navigating along a selected synthetic action sequence path 345/545 toward the desired end state 342/542. In this regard, the action prediction engine 300/500 may interface with the GUI 600 to provide an improved user interface for electronic devices that make it easier for the user to engage with the identified intermediate states 344/544 that are positively correlated with a user reaching the desired end state 342/542.

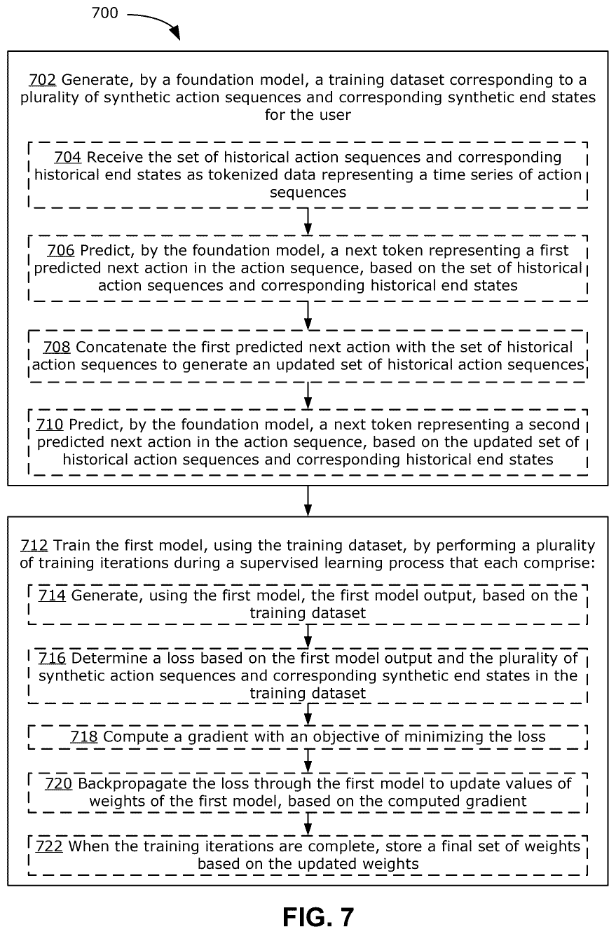

FIG. 7 is a flowchart of an example method 700 for generating a training dataset for training the compressed model (e.g., sequential action predictor 520), in accordance with examples of the present disclosure. The method 700 may be performed by the computing system 200. For example, a processing unit of a computing system (e.g., the processor 202 of the computing system 200 of FIG. 2) may execute instructions (e.g., instructions of the action prediction engine 300) to cause the computing system to carry out the example method 700. The method 700 may, for example, be implemented by an online platform or a server.

At an operation 702, a training dataset corresponding to a plurality of synthetic action sequences 335 and corresponding synthetic end states 342 for the user may be generated by a foundation model (e.g., generative recommender 320). In some examples, the foundation model may include the HSTU architecture. In examples, the training dataset may comprise a plurality of data samples, where each data sample represents a respective synthetic action 325 in a respective synthetic action sequence 335. In some embodiments, for example, for generating the training dataset the following operations 704-710 may be performed.

At an operation 704, a set of historical action sequences and corresponding historical end states may be received as tokenized data representing a time series of action sequences. At an operation 706, a next token representing a first predicted next action in the action sequence may be predicted by the foundation model, based on the set of historical action sequences and corresponding historical end states. At an operation 708, the first predicted next action may be concatenated with the set of historical action sequences to generate an updated set of historical action sequences. At an operation 710, a next token representing a second predicted next action in the action sequence may be predicted, by the foundation model, based on the updated set of historical action sequences and corresponding historical end states.

At an operation 712, the sequential action predictor 520 may be trained, using the training dataset during a supervised learning process, to minimize a loss between a compressed model output and the plurality of synthetic action sequences and corresponding synthetic end states. In examples, the sequential action predictor 520 may be a neural network model, and training the sequential action predictor 520 comprises performing a plurality of training iterations for training the first model during the supervised learning process. For each of the plurality of training iterations for training the sequential action predictor 520, the following operations 714-722 may be performed.

At an operation 714, the compressed model output may be generated, using the sequential action predictor 520, based on the training dataset. At an operation 716, a loss may be determined based on the compressed model output and the plurality of synthetic action sequences and corresponding synthetic end states in the training dataset. At an operation 718, a gradient may be computed with an objective of minimizing the loss. At an operation 720, the loss may be backpropagated through the sequential action predictor 520 to update values of weights of the sequential action predictor 520, based on the computed gradient. At an operation 722, when the training iterations are complete, a final set of weights may be stored based on the updated weights.

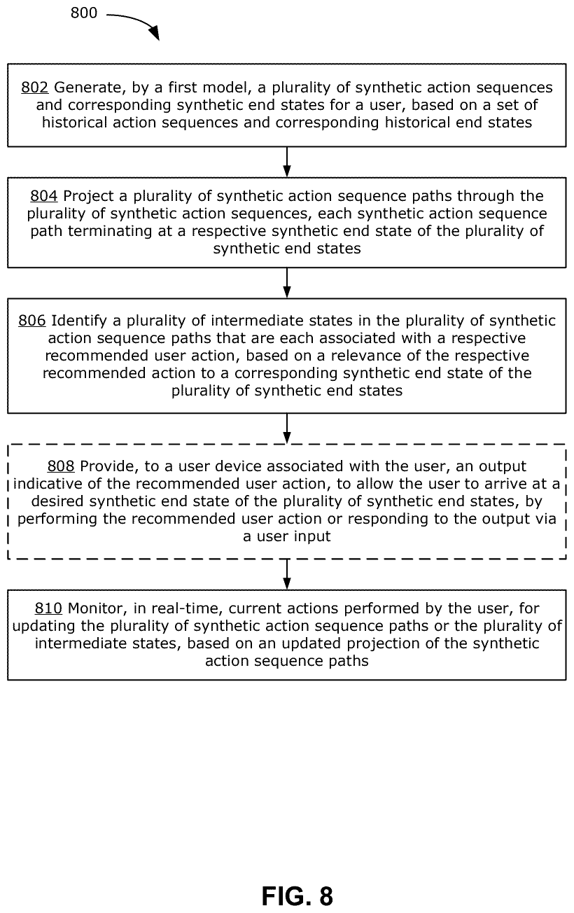

FIG. 8 is a flowchart of an example method 800 for implementing an action prediction framework associated with a user, in accordance with examples of the present disclosure. The method 800 may be performed by the computing system 200. For example, a processing unit of a computing system (e.g., the processor 202 of the computing system 200 of FIG. 2) may execute instructions (e.g., instructions of the action prediction engine 300 or 600) to cause the computing system to carry out the example method 800. The method 800 may, for example, be implemented by an online platform or a server.

At an operation 802, a plurality of synthetic action sequences 335 and corresponding synthetic end states 342 may be generated for a user, by a first model, based on an input data 310 including a set of historical action sequences and corresponding historical end states. In some embodiments, for example, the first model may be a foundation model, such as a generative recommendation model. In other embodiments, the first model may be a compressed model that has been trained (e.g., using knowledge distillation), to learn inherent features related to user behavior from the generative recommendation model, for example, for more efficiently generating the synthetic action sequences and pathways.

At an operation 804, a plurality of synthetic action sequence paths 345 may be projected through the plurality of synthetic action sequences 335, with each synthetic action sequence path 345 terminating at a respective synthetic end state 342 of the plurality of synthetic end states.

At an operation 806, a plurality of intermediate states 344 may be identified in the plurality of synthetic action sequence paths 345 that are each associated with a respective recommended user action 350, based on a relevance of the respective recommended action 350 to a corresponding synthetic end state 342 of the plurality of synthetic end states.

At an operation 808, an output indicative of the recommended user action 350 may be provided to a user device associated with the user, to allow the user to arrive at a desired synthetic end state of the plurality of synthetic end states 342, for example, by performing the recommended user action 350 or responding to the output via a user input.

At an operation 810, current actions performed by the user may be monitored in real-time, for updating the plurality of synthetic action sequence paths 345 or the plurality of intermediate states 344. In examples, an updated plurality of synthetic action sequences 335 may be generated, using the first model, to reflect the monitored current events, and an updated plurality of synthetic action sequence paths 345 may be projected through the updated plurality of synthetic action sequences 335. In examples, the plurality of intermediate states 344 may also be updated to account for the monitored current events, for example, based on the updated projection of synthetic action sequence paths 345.

Although the present disclosure describes methods and processes with operations (e.g., steps) in a certain order, one or more operations of the methods and processes may be omitted or altered as appropriate. One or more operations may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method comprising:
generating, by a first model, a plurality of synthetic action sequences and corresponding synthetic end states for a user, based on a set of historical action sequences and corresponding historical end states;
projecting a plurality of synthetic action sequence paths through the plurality of synthetic action sequences, each synthetic action sequence path terminating at a respective synthetic end state of the plurality of synthetic end states;
identifying a plurality of intermediate states in the plurality of synthetic action sequence paths that are each associated with a respective recommended user action, based on a relevance of the respective recommended action to a corresponding synthetic end state of the plurality of synthetic end states; and
monitoring, in real-time, current actions performed by the user, for updating the plurality of synthetic action sequence paths or the plurality of intermediate states, based on an updated projection of the synthetic action sequence paths.

2. The method of claim 1, further comprising:
providing, to a user device associated with the user, an output indicative of the recommended user action, to allow the user to arrive at a desired synthetic end state of the plurality of synthetic end states, by performing the recommended user action or responding to the output via a user input.

3. The method of claim 1, wherein the first model is a foundation model.

4. The method of claim 1, wherein the first model is a generative recommendation model.

5. The method of claim 1, wherein the first model includes a hypothetical sequential transduction unit (HSTU) architecture.

6. The method of claim 1, further comprising:
prior to generating a plurality of synthetic action sequences and corresponding synthetic end states for the user:
generating, by a foundation model, a training dataset corresponding to the plurality of synthetic action sequences and corresponding synthetic end states for the user, the training dataset comprising a plurality of data samples, each data sample representing a respective synthetic action in a respective synthetic action sequence; and
training the first model, using the training dataset during a supervised learning process, to minimize a loss between a first model output and the plurality of synthetic action sequences and corresponding synthetic end states.

7. The method of claim 6, wherein the first model is a compressed model and the foundation model includes HSTU.

8. The method of claim 6, wherein generating the training dataset comprises:
receiving the set of historical action sequences and corresponding historical end states as tokenized data representing a time series of action sequences;
predicting, by the foundation model, a next token representing a first predicted next action in the action sequence, based on the set of historical action sequences and corresponding historical end states;
concatenating the first predicted next action with the set of historical action sequences to generate an updated set of historical action sequences; and
predicting, by the foundation model, a next token representing a second predicted next action in the action sequence, based on the updated set of historical action sequences and corresponding historical end states.

9. The method of claim 6, wherein the first model is a neural network model, and training the first model comprises:
performing a plurality of training iterations for training the first model during the supervised learning process that each comprise:
generating, using the first model, the first model output, based on the training dataset;
determining a loss based on the first model output and the plurality of synthetic action sequences and corresponding synthetic end states in the training dataset;
computing a gradient with an objective of minimizing the loss; and
backpropagating the loss through the first model to update values of weights of the first model, based on the computed gradient; and
when the training iterations are complete, storing a final set of weights based on the updated weights.

10. The method of claim 1, wherein monitoring current actions comprises:
comparing the current actions with one or more synthetic actions associated with a selected one of the plurality of synthetic action sequence paths to determine a deviation from the selected synthetic action sequence path;
determining an updated desired end state of the plurality of synthetic end states for the user, the updated desired end state being associated with the current actions;
projecting an updated synthetic action sequence path through an updated plurality of synthetic action sequences, the updated synthetic action sequence path terminating at the updated desired end state; and
identifying an updated intermediate state along the updated synthetic action sequence path representing an updated recommended user action, based on a relevance of the updated recommended user action to the desired end state.

11. A computer system comprising:
a processing unit configured to execute computer-readable instructions to cause the system to:
generate, by a first model, a plurality of synthetic action sequences and corresponding synthetic end states for a user, based on a set of historical action sequences and corresponding historical end states;
project a plurality of synthetic action sequence paths through the plurality of synthetic action sequences, each synthetic action sequence path terminating at a respective synthetic end state of the plurality of synthetic end states;
identify a plurality of intermediate states in the plurality of synthetic action sequence paths that are each associated with a respective recommended user action, based on a relevance of the respective recommended action to a corresponding synthetic end state of the plurality of synthetic end states; and
monitor, in real-time, current actions performed by the user, for updating the plurality of synthetic action sequence paths or the plurality of intermediate states, based on an updated projection of the synthetic action sequence paths.

12. The computer system of claim 11, wherein the processing unit is further configured to execute computer-readable instructions to cause the computer system to:
provide, to a user device associated with the user, an output indicative of the recommended user action, to allow the user to arrive at a desired synthetic end state of the plurality of synthetic end states, by performing the recommended user action or responding to the output via a user input.

13. The computer system of claim 11, wherein the first model is a foundation model.

14. The computer system of claim 11, wherein the first model is a generative recommendation model.

15. The computer system of claim 11, wherein the first model includes a hypothetical sequential transduction unit (HSTU) architecture.

16. The computer system of claim 11, wherein the processing unit is further configured to execute computer-readable instructions to cause the computer system to:
prior to generating a plurality of synthetic action sequences and corresponding synthetic end states for the user:
generate, by a foundation model, a training dataset corresponding to the plurality of synthetic action sequences and corresponding synthetic end states for the user, the training dataset comprising a plurality of data samples, each data sample representing a respective synthetic action in a respective synthetic action sequence; and
train the first model, using the training dataset during a supervised learning process, to minimize a loss between a first model output and the plurality of synthetic action sequences and corresponding synthetic end states.

17. The computer system of claim 16, wherein the first model is a compressed model and the foundation model includes HSTU.

18. The computer system of claim 16, wherein in generating the training dataset, the processing unit is further configured to execute computer-readable instructions to cause the computer system to:
receive the set of historical action sequences and corresponding historical end states as tokenized data representing a time series of action sequences;
predict, by the foundation model, a next token representing a first predicted next action in the action sequence, based on the set of historical action sequences and corresponding historical end states;
concatenate the first predicted next action with the set of historical action sequences to generate an updated set of historical action sequences; and
predict, by the foundation model, a next token representing a second predicted next action in the action sequence, based on the updated set of historical action sequences and corresponding historical end states.

19. The computer system of claim 16, wherein the first model is a neural network model, and wherein in training the first model, the processing unit is further configured to execute computer-readable instructions to cause the computer system to:
perform a plurality of training iterations for training the first model during the supervised learning process that each comprise:
generating, using the first model, the first model output, based on the training dataset;
determining a loss based on the first model output and the plurality of synthetic action sequences and corresponding synthetic end states in the training dataset;
computing a gradient with an objective of minimizing the loss; and
backpropagating the loss through the first model to update values of weights of the first model, based on the computed gradient; and
when the training iterations are complete, store a final set of weights based on the updated weights.

20. A non-transitory computer-readable medium storing instructions that, when executed by a processing unit of a computing system, cause the computing system to:
generate, by a first model, a plurality of synthetic action sequences and corresponding synthetic end states for a user, based on a set of historical action sequences and corresponding historical end states;
project a plurality of synthetic action sequence paths through the plurality of synthetic action sequences, each synthetic action sequence path terminating at a respective synthetic end state of the plurality of synthetic end states;
identify a plurality of intermediate states in the plurality of synthetic action sequence paths that are each associated with a respective recommended user action, based on a relevance of the respective recommended action to a corresponding synthetic end state of the plurality of synthetic end states; and
monitor, in real-time, current actions performed by the user, for updating the plurality of synthetic action sequence paths or the plurality of intermediate states, based on an updated projection of the synthetic action sequence paths.
